(19) United States
(12) Patent Application Publication
(10) Pub. No.: US 2009/0259524 A1
(43) Pub. Date: Oct. 15, 2009

(54) USER-ASSISTED ONLINE TRANSACTIONS

(76) Inventor: Victor Rozenkrants, San Diego, CA (US)

Correspondence Address: LOZA & LOZA LLP, 305 N. Second Avenue, #127, Upland, CA, 91786-6064, US

(21) Appl. No.: 12/422,095

(22) Filed: Apr. 10, 2009

Related U.S. Application Data
(60) Provisional application No. 61/044,499, filed on Apr. 13, 2008.

(51) Int. Cl. G06Q 30/00; G06Q 10/00; G06Q 20/00

(52) U.S. Cl. 705/10; 705/14; 705/40; 705/26

(57) ABSTRACT

One feature provides an online system that assists users (or sponsors) in selecting and purchasing goods and/or services for themselves and/or others (or recipients). A sponsor may provide the funds for the purchase but delegate the purchase decision to an assistant user or group of assistant users (also referred to as a “voting group”) within an online network community or social group. The voting group may have the autonomy as to the specific item (good and/or service) to buy and make purchase decisions on behalf of the sponsor. The sponsor may set limits on the amount to spend for any particular gift or a particular period of time within which to purchase any particular gift. This online system removes the specific buying decision (e.g., which particular item to buy, researching particular items, or shopping for an item) from the sponsor, thereby saving the sponsor time.

### CLAIM OF PRIORITY UNDER 35 U.S.C. §119

The present Utility Application for Patent claims priority to U.S. Provisional Application No. 61/044,499 entitled “User-Assisted Online Transactions” filed Apr. 13, 2008, and is hereby expressly incorporated by reference herein.

### FIELD

The present invention relates to systems and methods for business transactions, and more specifically to systems and methods for assisting users with the purchase of goods and/or services.

### BACKGROUND

With the number of hours people work on the rise, it is becoming increasingly difficult for people to take care of personal matters, such as shopping for items for themselves and/or gifts for others. Some have attempted to address this problem by providing services to assist users or gift givers who do not have the time or desire to shop. These services have included a gift concierge and travel agent services that provide professional advice on selecting a good and/or service to purchase. In addition, these services may act as a middle-man for performing the actual transaction, thereby adding convenience to the user or gift giver.

If a user or gift giver does not want to utilize a professional service, he/she may look to user reviews for guidance. Many online sites allow consumers to share ratings and reviews of goods and services as well as provide the ability to conduct online polls where consumers can vote for their favorite goods and services. There are also gift registries which allow recipients to select a “wish list” of goods and services they would like to receive. The gift registries also typically keep track of which goods and services on the list have already been purchased. Another option that has become popular is virtual gifts. Virtual gifts may include a picture of a good, instead of the good itself, usually through the internet, or of a good in a virtual world. The good may have social capital value, aesthetic or functional value. The good may or may not be paired with an offline equivalent.

However, these services still require substantial time and/or direct involvement from the user or gift giver, time which the user or gift giver may not have. Furthermore, most of these services are expensive and impersonal. Therefore, a system is needed that is cost effective, personalized, and assists users or gift givers in selecting and purchasing goods and/or services for themselves and/or others.

### SUMMARY

A method and/or apparatus are provided for an online system that assists users (also referred to as “sponsors”) in selecting and purchasing goods and/or services for themselves and/or others (also referred to as “recipients”). A sponsor may provide the funds for the purchase but delegate the purchase decision to an assistant user or group of assistant users (also referred to as a “voting group”) within an online network community or social group. The voting group may have the autonomy as to the specific item (good and/or service) to buy and make purchase decisions on behalf of the sponsor. The sponsor may set limits on the amount to spend for any particular gift or a particular period of time within which to purchase any particular gift. This online system removes the specific buying decision (e.g., which particular item to buy, researching particular items, or shopping for an item) from the sponsor, thereby saving the sponsor time.

Some implementations of the present invention may allow a sponsor to select one or more members of the voting group within an online network community to purchase gifts (e.g., anniversary gifts, holiday gifts, birthday gifts, etc.) and/or items (e.g., books, wines, etc.) intended for the sponsor or others on behalf of the sponsor (i.e., recipient) using funds provided by the sponsor. Alternatively, the funds may come from a third party, a merchant or even members of the voting group may contribute to the funds. The sponsor may select a particular member or members from a community of users whom the sponsor trusts in terms of tastes and/or choices. For example, a sponsor may trust the choices of a particular book reviewer or wine taster in an online community because the sponsor may have similar tastes.

The secure online system may allow the sponsor to deposit funds in an escrow account for the business transaction, provide his/her credit card information or otherwise allow assistant users to spend funds on behalf of the sponsor. Alternatively, the funds may come from a third party, a merchant or even members of the voting group may contribute to the funds. Furthermore, there may be more than one sponsor for a transaction.

A transaction manager may establish the rules and framework by which the sponsor permits one or more voters in an online community to choose the gift on behalf of the sponsor. An online broker may perform as the transaction manager to facilitate the interaction between the sponsors, voting groups, merchants, and by holding funds in escrow, obtaining authorization to use the funds, putting a hold of funds, charging a credit card of the sponsor directly and/or allowing a merchant to charge the sponsor directly for the business transaction. While the voting group may have autonomy in selecting and/or purchasing items on behalf of the sponsor, the transaction manager may prevent the voting group from using those funds for themselves or direct them to other purposes not approved by the sponsor.

The transaction manager may also collect information about the online transactions that it facilitates. This information may be provided to merchants and/or advertisers in order to better target purchasers and/or identify popular items. For example, the collected data is further analyzed to determine at least one of (or a combination of): (a) the most selected items for a particular age group (e.g., sponsor, voter, and/or recipient age group), (b) the most selected items for a particular gender; (c) the most selected items by price range, (d) the most selected items by category (e.g., electronics, food, wines, books, etc.), (e) the most selected items by occasion (e.g., anniversaries, holidays, birthdays, etc.), and/or (f) the most selected items by geographical region. The collected data may be distributed to merchants or others by the transaction manager. This may facilitate advertising of items by merchants based on the collected data. For instance, a merchant may better focus its advertising to specific voter groups based the recipient's age, or the voter's age, and/or the occasion for which the item is being selected.

The system of the present invention may also provide an online portal that a sponsor can use to provide himself/herself (as recipient) with a surprise gift that is selected and purchased by one or more members of the voting group but paid for by funds provided by the sponsor. In this manner, the sponsor can receive “surprise” gifts on his/her birthday, Valentine's Day, Christmas, or other occasions.

Additionally, a processing device (such as a computer) may be adapted to implement assisting a sponsor with an online transaction. The processing device may include (a) means for for securing funds for the online transaction; (b) means for obtaining an item selection from a third party voting group; (c) means for authorizing access the funds to a merchant for purchasing the item for a recipient on behalf of the sponsor; (d) means for notifying one or more members of the voting group of the online transaction, the one or more members of the voting group select the item for the sponsor to provide to the recipient; and means for notifying a transaction manager of the item selection by the one or more members of the voting group.

### BRIEF DESCRIPTION OF THE DRAWINGS

FIG. 1 is a block diagram illustrating the general structure of an online assisted shopping system.

FIG. 2 is a block diagram illustrating how an online assistance system may facilitate a sponsor in obtaining/buying goods and/or services for a recipient but delegate the decision of what specific goods and/or services to obtain to one or members of a voting group.

FIG. 3 is a block diagram illustrating another example of a user-assisted online assistance system configured to assist a sponsor to delegate a transaction to one or more assistants.

FIG. 4 is a flow diagram illustrating a method operational in a user-assisted online assistance system for selecting and purchasing an item or gift for a recipient.

FIG. 5 is a flow diagram illustrating a method operational in a user-assisted online assistance system for selecting and purchasing an item or gift for a recipient.

FIG. 6 is a flow diagram illustrating another method operational in a user-assisted online assistance system for selecting and purchasing an item or gift for a recipient.

FIG. 7 is a block diagram of a computing system for executing computer executable process steps according to one embodiment of the disclosure.

FIG. 8 is a block diagram illustrating the internal functional architecture of the computer.

FIG. 9 shows a typical topology of a computer network with computers similar to computer of FIG. 7, connected to the Internet.

### DETAILED DESCRIPTION OF THE INVENTION

In the following description, specific details are given to provide a thorough understanding of the embodiments. However, it will be understood by one of ordinary skill in the art that the embodiments may be practiced without these specific details. For example, software modules, functions, circuits, etc., may be shown in block diagrams in order not to obscure the embodiments in unnecessary detail. In other instances, well-known modules, structures and techniques may not be shown in detail in order not to obscure the embodiments.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

According to one feature of the present invention, an online system is provided that assists users (also referred to as “sponsors”) in selecting and purchasing goods and/or services for themselves and/or others (also referred to as “recipients”). A sponsor may provide the funds for the purchase but delegate the purchase decision to an assistant user or group of assistant users (also referred to as a “voting group”) within an online network community or social group. The voting group may have the autonomy as to the specific item (good and/or service) to buy and make purchase decisions on behalf of the sponsor. The sponsor may set limits on the amount to spend for any particular gift or a particular period of time within which to purchase any particular gift. This online system removes the specific buying decision (e.g., which particular item to buy, researching particular items, or shopping for an item) from the sponsor, thereby saving the sponsor time.

Some implementations of the present invention may allow a sponsor to select one or more members of the voting group within an online network community to purchase gifts (e.g., anniversary gifts, holiday gifts, birthday gifts, etc.) and/or items (e.g., books, wines, services, etc.) intended for the sponsor or others on behalf of the sponsor (i.e., recipient) and using funds provided by the sponsor or others. The sponsor may select a particular member or members from a community of users whom the sponsor trusts in terms of tastes and/or choices. For example, a sponsor may trust the choices of a particular book reviewer or wine taster in an online community because the sponsor may have similar tastes.

Yet another feature provides a secure online system in which the sponsor can deposit funds or provide credit card information or otherwise allow assistant users (i.e. members of the voting group) to spend funds on behalf of the sponsor. Alternatively, the funds may come from a third party, a merchant or even members of the voting group may contribute to the funds. Furthermore, there may be more than one sponsor for a transaction. An online broker may perform as the transaction manager to facilitate the interaction between the sponsors, voting groups, merchants, and by holding funds in escrow, obtaining authorization to use funds, putting a hold of funds, charging a credit card of the sponsor or other directly and/or allowing a merchant to charge the sponsor directly. While the voting group may have autonomy in selecting and/or purchasing items on behalf of the sponsor, the transaction manager may prevent the voting group from using those funds for themselves or direct them to other purposes not approved by the sponsor.

Yet another aspect provides for an online portal that a sponsor can use to provide himself/herself (as recipient) with a surprise gift that is selected and purchased by one or more members of the voting group but paid for by funds provided by the sponsor, or from a third party, a merchant or even members of the voting group. In this manner, the sponsor can receive “surprise” gifts on his/her birthday, Valentine's Day, Christmas, or other occasions.

### Online Assisted Shopping System

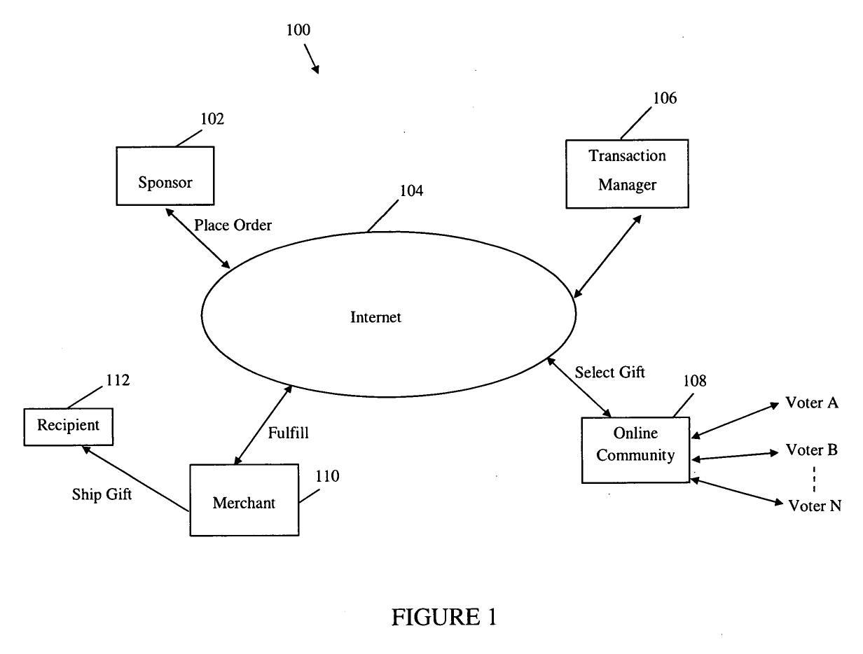

FIG. 1 is a block diagram illustrating the general structure of an online assisted shopping system 100. A sponsor 102 may wish to purchase a gift for a recipient 112 without having to actually shop and/or research for the gift him/herself. The sponsor 102 may be coupled to a network 104, such as the Internet, through which it communicates with a transaction manager 106. The transaction manager 106 may establish the rules and framework by which the sponsor permits one or more voters (or members or users) in an online community 108 to choose the gift on behalf of the sponsor 102. The transaction manager 106 may then process an order for the selected gift through a merchant 110. The gift may then shipped to the recipient 112 identified by the sponsor 102.

### Example of Assisted Shopping System

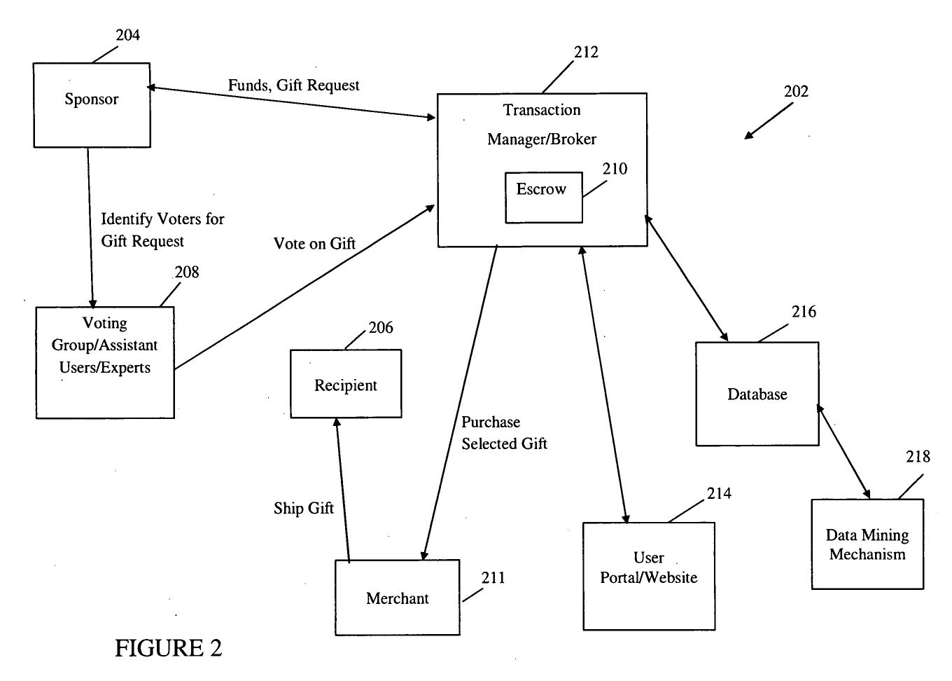

FIG. 2 is a block diagram illustrating how an online assistance system 202 may facilitate a sponsor 204 in obtaining/buying goods and/or services for a recipient 206 but delegate the decision of what specific goods and/or services to obtain to one or members (or voters) of a voting group 208 (or a group of experts). The term “sponsor” refers to any person or entity (e.g., gift giver) providing funds for an online business transaction using the online assistance system 202. The funds may provide the resources to purchase the goods and/or services for the recipient 206. The term “fund” refers to any form of tender, including but not limited to, wire transfer, credit cards, store credit, reward points, virtual currency, barter, third party payment methods (Google®, PayPal®), etc. The sponsor and the recipient may be the same person or entity or a different person or entity.

To initiate the transaction, the sponsor 204 may deposit funds into escrow 210 which are held by a transaction manager (or broker) 212. The transaction manager 212 may be responsible for sending out invitations to join the voting group 208, maintaining a list of members of the voting group 208, hold the funds in escrow 210, distributing the funds to a merchant 211, receiving the goods and/or services for distribution to the sponsor 204 or recipient 206. Once the funds have been deposited in escrow 210, the voting group 208 may be notified and may begin voting on goods and/or services to purchase for the recipient 206.

In an alternative embodiment (not shown), the escrow 210 may be separate or independent from the transaction manager 212.

In yet another embodiment, the sponsor 204 may authorize charging his/her credit card, or other, directly and/or allowing a merchant to charge him/her directly instead of depositing funds into escrow.

In still another embodiment, the funds may come from a third party, a merchant or even members of the voting group may contribute to the funds. Furthermore, there may be more than one sponsor for a transaction.

In one embodiment, the voting group 208 may be associated with, or selected by, the sponsor 204 and/or recipient 206 via an online community or social group such as MySpace®, Bebo®, Facebook®, Friendster®, and the like. By using social groups, some information may be known about the recipient 206, such as the recipient's age. The recipient's age may then be used to select age appropriate goods and/or services or goods and/or services the people having a similar age prefer.

In one embodiment, the sponsor 204 and/or recipient 206 may provide contact information, such as email addresses, for all individuals that are to be included in the voting group 208. The individuals may then be sent an invitation to join the voting group 208 and/or social network.

In an alternative embodiment, instead of using a group of the recipient's friends for the voting group 208, the transaction manager 212 may randomly select a gift based on a statistical selection of what the members of the voting group prefer.

In an alternative embodiment, the sponsor 204 may select the members of the voting group 208 that he or she is familiar with. For instance, the members of the voting group 208 may be a person or entity whom the sponsor 204 trusts in terms of tastes, styles, and/or judgment to select an appropriate item for the recipient 206. Thus, the voting group 208 may have the autonomy as to the specific item to buy and make purchase decisions on behalf of the sponsor 204. According to an optional feature, the voting group 208, transaction manager 212 or merchant 211 may add additional funds to the funds that the sponsor 204 has already contributed.

In an alternative embodiment, the voting group 208 may use expert advice, such as reviews and ratings of items from members of a club, such as a book club or a wine club. If expert advice is used, the process of selecting a gift may be automated. For example, the voting group 208 may automatically select the wine that was rated the best by the wine club. The selection may also be made based upon past voting history or on a statistical basis.

In another embodiment, the experts may be rated. For example, if the recipient 206 likes the gift picked by the expert, the transaction manager 212, sponsor 204 and/or recipient 206 may rate the expert's performance. These ratings may be exposed to others throughout the network and so that others may seek out the assistance of the highly rated experts.

Once the voting group 208 has decided upon any goods and/or services, the voting group 208 may notify the transaction manager 212 of the selection. The transaction manager 212 may then purchase the selected goods and/or services by transferring the funds held in escrow 210 to a merchant 211 which may then ship the goods and/or services directly to the recipient 206 or to the transaction manager 212 for delivery to the recipient 206. Alternatively, instead of utilizing funds in an escrow account, the transaction manager 212 may obtain authorization to charge the sponsor's credit card directly and/or allow a merchant to charge the sponsor directly.

In one embodiment, the sponsor 204 may specify limits that control the transaction, such as the amount to spend for any particular gift or the transaction may occur within a particular period of time. This online assistance system 202 may remove the specific buying decision (e.g., which particular item to buy, researching particular items, or shopping for an item) from the sponsor 204, thereby saving the sponsor 204 time.

In one embodiment, the transaction manager 212 may have its own portal or website 214 through which third parties which are not part of a social network may participate in transactions. For instance, the sponsor may identify one or more third parties (that are not part of a social network) to be voters in a particular gift request. For instance, such third parties may be friends, relatives, and/or colleagues of the sponsor and/or recipient. The third parties may also add additional funds to the funds that the sponsor 204 has already contributed.

In another embodiment, data about the gift selections may be stored in a database 216 which may be used for marketing purposes. A data mining mechanism 218 may be used to provide targeted marketing information. For example, if one particular expert is highly rated, it is likely that others will follow the advice of that expert. The expert may provide what is good or bad about a specific product which may prompt others to discuss the pros and cons of particular products, goods and/or services.

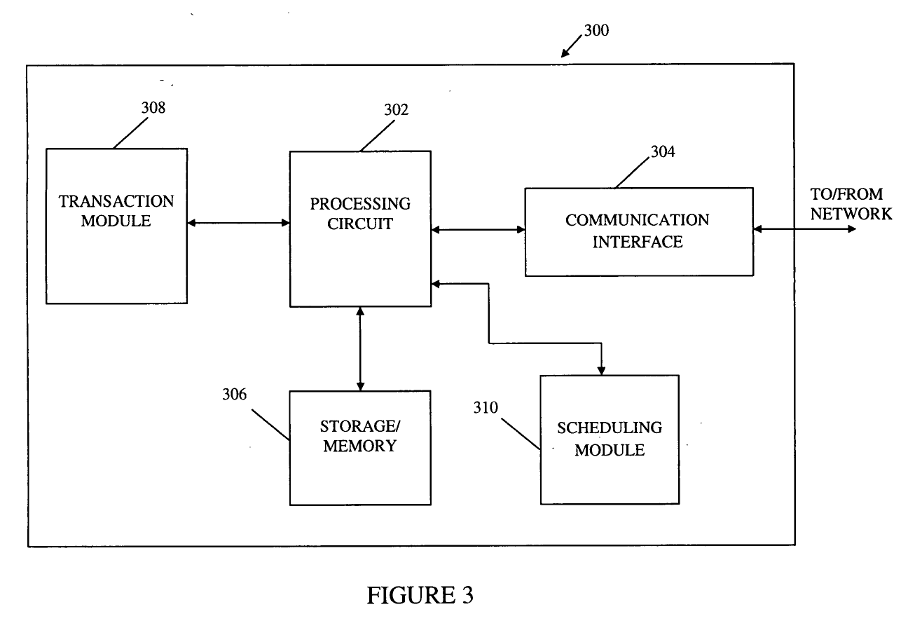

FIG. 3 is a block diagram illustrating another example of a user-assisted online assistance system 300 configured to assist a sponsor to delegate a transaction to one or more assistants. The system 300 may include a processing circuit 302 (e.g., processor, processing module, etc.) coupled to a communication interface 304 to communicate with a network, such as the Internet, and a memory device 306 to store restrictions/controls/limits/parameters of the transaction provided by the sponsor. The restrictions/controls/limits/parameters may include, but are not limited to, the upper and lower limits of the budget, characteristics of the recipient such as interests and activities, specific dates associated with the recipient such as a birthday or anniversary, deadlines and whether the transaction is to be a recurring transaction. The processing circuit 302 may be coupled to a transaction module 308 to analyze the restrictions/controls/limits/parameters and provide a suggested list of goods and/or services (e.g., gifts) to purchase to complete the transaction. A scheduling module 310 may also be coupled to the processing circuit 302 to schedule the delivery of the gifts to the recipient.

### Social Network Implementation

The online assistance system 202 may be implemented within various network architectures and/or implementations. For instance, the online assistance system 202 may be implemented within any type of service focused on the building and leveraging of online social networks for communities of people who share interests and activities, or who are interested in exploring the interests and activities of others. Alternatively, the online assistance system 202 may be implemented on a stand-alone website, such as MySpace®, Bebo®, Facebook®, and Friendster®.

According to one feature, the online assistance system may not utilize real-time feedback from members of the voting group in selecting items but rather may rely on prior reviews or opinions from one or more of the members in making an item selection. For instance, the online assistance system may obtain item selections from certain members (e.g., online community users, book reviewers, Amazon® customer reviews, Netflix® suggestions, etc.) to make an item selection on behalf of the sponsor.

According to one example of an implementation of the online assistance system, a method and system are provided for assisting a sponsor in completing a transaction. The transaction may allow the sponsor to use the assistance of a voting group to make a purchase of a good and/or service for a recipient. The recipient may be a wife, child, sibling, parent, friend, teacher, co-worker or anyone else the sponsor would like to provide with a gift of a good and/or service. The sponsor may provide the funds and certain criteria, parameters or guidelines for the voting group to follow. A transaction manager organizes the transaction and may select or identify the members of the voting group to research/select the possible goods and/or services to purchase, purchase the goods and/or services and ensure the goods and/or services are delivered to the recipient in the appropriate manner and at the appropriate time. In some implementations, the criteria, parameters or guidelines may be provided by the online assistance system.

In one embodiment, a deadline may be specified for the execution of the transaction. The deadline may be specified by the sponsor, the transaction manager, and/or the members of the voting group. In another example, the voting group may request a change to the transaction deadline. The sponsor may consider and/or act upon the request to change the transaction deadline.

The online assistance system may operate as a transaction broker to ensure that the transaction is initiated and/or completed prior to or soon after the deadline. The online assistance system may fulfill an item selection based on the actions of the voting group up to the time of the selection of the goods and/or services, may make the selection randomly or may make the selection based on input from other entities.

In one embodiment, a recurrence schedule may be specified for the gift request. The sponsor may specify the recurrence schedule for the gift request. For example, goods and/or services (or gifts) may be sent to a recipient on a recurring basis, such as once a month, particular days determined by the sponsor, such as a birthday or anniversary, etc.

### Spending Group (Assistants)

The voting group 208 allowed to purchase items and/or services on behalf of the sponsor may include any individual, entity, and/or group of entities authorized, either explicitly or implicitly, by the sponsor. The voting group may be one or more members of the recipient's social network. As the recipient's social network may be familiar with the likes and dislikes of the recipient, the social network may be in a better position to select the gift.

According to one feature, the members of the voting group may be offered rewards to motivate them to select items that are acceptable to the sponsor. For instance, the online assistance system may track whether the sponsor keeps or returns the gift, or inquires whether the sponsor found the item acceptable. Consequently, the members of the voting group may be offered incentives to achieve a history of successful item selections.

### Funds

A sponsor may provide funds to the online assistance system either before, concurrent with, or after a transaction has been completed. For instance, the sponsor may authorize spending by transferring funds into an escrow account to which the members of the voting group have access. The online assistance system may utilize these funds to pay for items selected/purchased on behalf of the sponsor. The sponsor may set limits as to how much to spend for any particular transaction. In one embodiment, lower and/or upper limits for the funds or budget for the transaction may be specified. The limits may be specified by the sponsor or one or more members of the voting group. Additionally, a sponsor may specify lower and/or upper limits for the budget available to one or more members of the voting group. Alternatively, instead of utilizing funds in an escrow account, the transaction manager 212 may obtain authorization to charge the sponsor's credit card directly, charge the credit care of another directly and/or allow a merchant to charge the sponsor directly.

In some implementations, merchants, advertisers, or other third parties may increase the sponsor's budget for a particular transaction.

### Goods/Services

In one embodiment, the sponsor and/or the transaction manger may restrict, via optional and/or mandatory requirements or parameters, the set of merchants that may be utilized to complete the transaction and/or the types of goods and/or services to acquire.

### Data Mining

In yet another feature, the transaction manager may collect information about the online transactions that it facilitates. This information may be provided to merchants and/or advertisers in order to better target purchasers and/or identify popular items. For example, the collected data is further analyzed to determine at least one of (or a combination of): (a) the most selected items for a particular age group (e.g., sponsor, voter, and/or recipient age group), (b) the most selected items for a particular gender; (c) the most selected items by price range, (d) the most selected items by category (e.g., electronics, food, wines, books, etc.), (e) the most selected items by occasion (e.g., anniversaries, holidays, birthdays, etc.), and/or (f) the most selected items by geographical region. The collected data may be distributed to merchants or others by the transaction manager. This may facilitate advertising of items by merchants based on the collected data. For instance, a merchant may better focus its advertising to specific voter groups based the recipient's age, or the voter's age, and/or the occasion for which the item is being selected.

### Example Methods

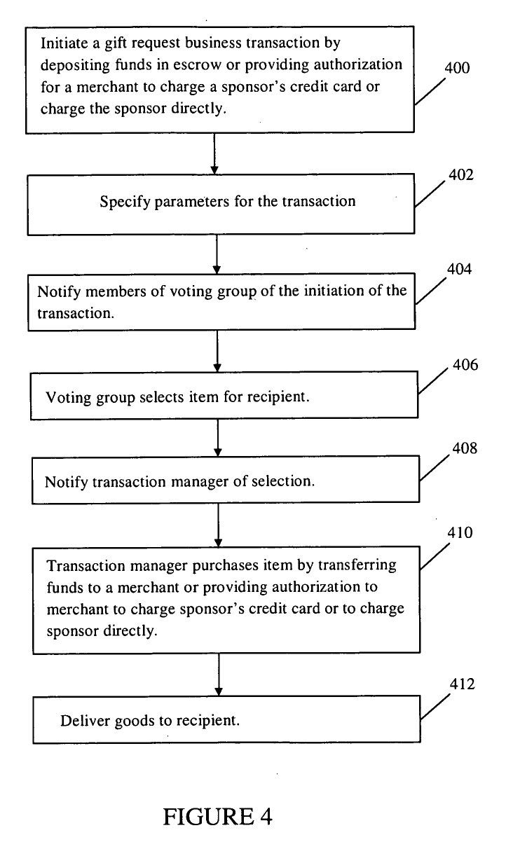

FIG. 4 is a flow diagram illustrating a method operational in a user-assisted online assistance system for selecting and purchasing an item or gift for a recipient. Initially, the sponsor may initiate a gift request transaction by depositing funds in escrow 400. Alternatively, the sponsor may provide authorization to charge the sponsor's credit card directly, charge the credit card of another directly and/or allow a merchant to charge the sponsor directly. Next, the sponsor may specify the parameters for the transaction 402. For example, the sponsor may specify the type of item/gift to purchase for a recipient as well as the members of the voting group. The item or gift may be any type of good and/or service. Alternatively, the sponsor may opt to have someone else select the type of item or gift. Additionally, upper and lower limits of the budget may be set by the sponsor along with a deadline of completing the transaction. Once the transaction is initiated and the parameters are defined, members of the voting group may be notified as to the initiation of the transaction 404. Next, the members of the voting group select the item to be purchased for the recipient 406. The voting group may vote on the item. The voting group may be provided with a list of items from which to select for the members of the voting group may suggest items to vote on. Once the item has been selected, the voting group notifies the transaction manager for the selected item 408. The transaction manger may then purchase the item by transferring the funds held in escrow to a merchant providing the item 410. Alternatively, the transaction manager may provide authorization to charge the sponsor's credit card directly, charge the credit card of another directly and/or allow a merchant to charge the sponsor directly. Once the item has been purchased, it is delivered to the recipient 412. The merchant may ship the item directly to the recipient or may ship the item to the sponsor or the transaction manager.

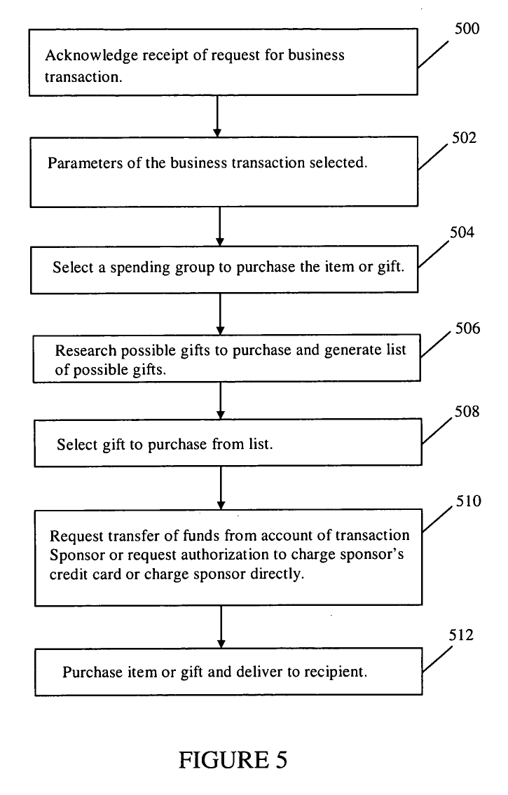

FIG. 5 is a flow diagram illustrating a method operational in a user-assisted online assistance system for selecting and purchasing an item or gift for a recipient. A request for a transaction from a sponsor may be acknowledged 500. Parameters of the business transaction may be selected by the sponsor 502. The parameters may include the price range, color, style or type of item or gift. A voting group may then be selected by an online assistance system or sponsor to search for the item or gift 504. The voting group may then research items that match the parameters and generate a list of possible items or gifts to purchase for the recipient 506. From the list, the item or gift may be selected and purchased 508. Next, a request may be made to transfer funds from an account of the sponsor so that the item or gift may be purchased 510. Alternatively, a request may be made to charge the sponsor's credit card directly, charge the credit card of another directly and/or allow a merchant to charge the sponsor directly. Finally, the item or gift is purchased and delivered to the recipient 512.

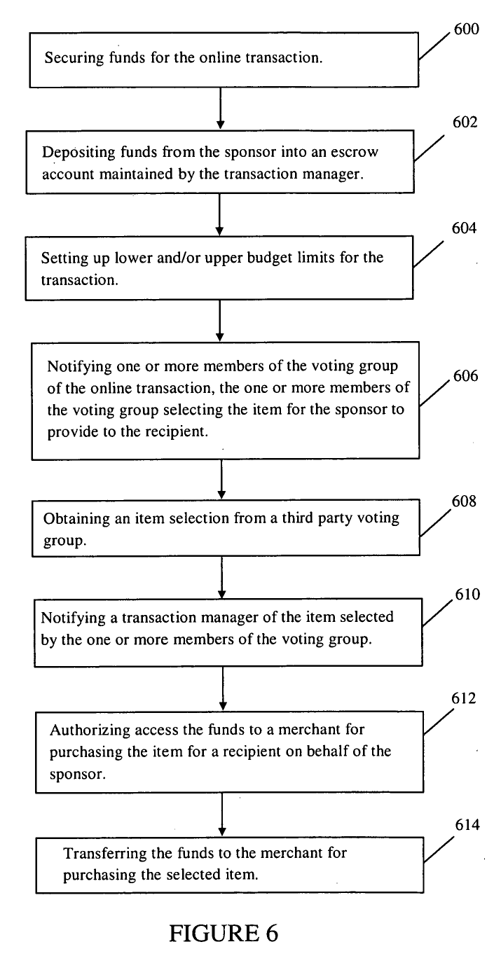

FIG. 6 is a flow diagram illustrating another method operational in a user-assisted online assistance system for selecting and purchasing an item or gift for a recipient. Initially, the transaction manager may secure funds for the online transaction from the sponsor 600. The secured funds may then be deposited into an escrow account maintained by the account manager 602. Alternatively, instead of securing funds by depositing funds in an escrow account, the transaction manager may obtain authorization to charge the sponsor's credit card directly and/or allow a merchant to charge the sponsor directly. Next, the sponsor may specify the parameters for the transaction by setting up lower and/or upper budget limits for the transaction 604. Once the funds have been secured and the parameters specified, one or more members of a voting group of the online transaction for selecting the item for the sponsor to provide to the recipient may be notified 606. The item is select by the third party voting group and the item selection is obtained by the system 608. Next, the transaction manager is notified of the item selected by the one or more members of the voting group 610. Authorized access to the secured funds may then be granted to a merchant for purchasing the item for the recipient on behalf of the sponsor 612. Once access is granted, the funds may be transferred to the merchant for purchasing the selected item.

### Operating Environment

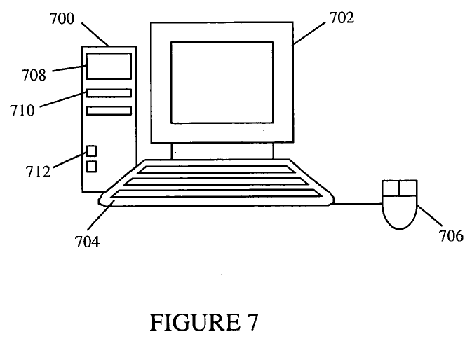

Various features of the online system described herein may be implemented over networked computing devices. FIGS. 7, 8, and 9 provide some examples of the type of devices and networks that may implement one or more features of the invention.

FIG. 7 is a block diagram of a computing system for executing computer executable process steps according to one embodiment of the disclosure. FIG. 7 includes a host computer 700 and a monitor 702. The monitor 702 may be a CRT type, an LCD type, or any other type of color or monochrome display. Also provided with the computer 700 is a keyboard 704 for entering text data and user commands, and a pointing device 706 (such as a mouse) for processing objects displayed on the monitor 702.

The computer 700 may include a computer-readable memory/medium such as a disk 708 for storing readable data. Besides other programs, the disk 708 can store application programs including web browsers by which the computer 700 connects to the Internet and the systems described below, according to one aspect of the disclosure.

A modem, an integrated services digital network (ISDN) connection, or the like may also provide the computer 700 with a DSL/Cable/satellite connection (or Internet connection) to the World Wide Web (“WWW”). The Internet connection may be used to allow the computer 600 to download data files, audio files, application program files and computer-executable process steps embodying the disclosure.

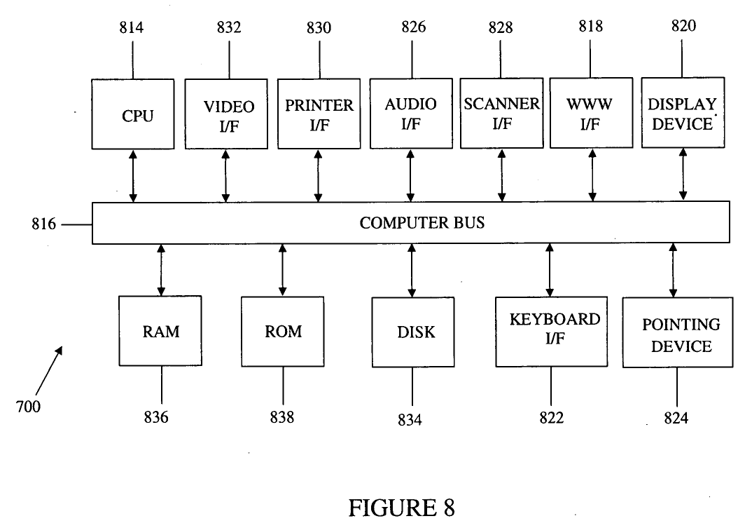

FIG. 8 is a block diagram illustrating the internal functional architecture of the computer 700. As shown in FIG. 8, the computer 700 may include a central processing unit (CPU) 814 for executing computer-executable process steps and interfaces with a computer bus 816. Also shown in FIG. 8 are a WWW interface 818, a display device interface 820, a keyboard interface 822, a pointing device interface 824, an audio interface 826, a scanner interface 828, a printer interface 830, a video interface 832, and a rotating disk 834. The scanner interface 828 can connect to a check scanner or imager (not shown) and a fingerprint scanner (not shown).

As described above, the disk 834 may store operating system program files, application program files, web browsers, and other files. Some of these files may be stored on the disk 834 using an installation program. For example, the CPU 814 may execute computer-executable process steps of an installation program so that the CPU 814 can properly execute the application program.

A random access main memory (“RAM”) 836 may also interface to the computer bus 816 to provide the CPU 814 with access to memory storage. When executing stored computer-executable process steps from the disk 834, the CPU 814 stores and executes the process steps out of the RAM 836.

Read only memory (“ROM”) 838 may be provided to store invariant instruction sequences such as start-up instruction sequences or basic input/output operating system (BIOS) sequences for operation of the keyboard 822.

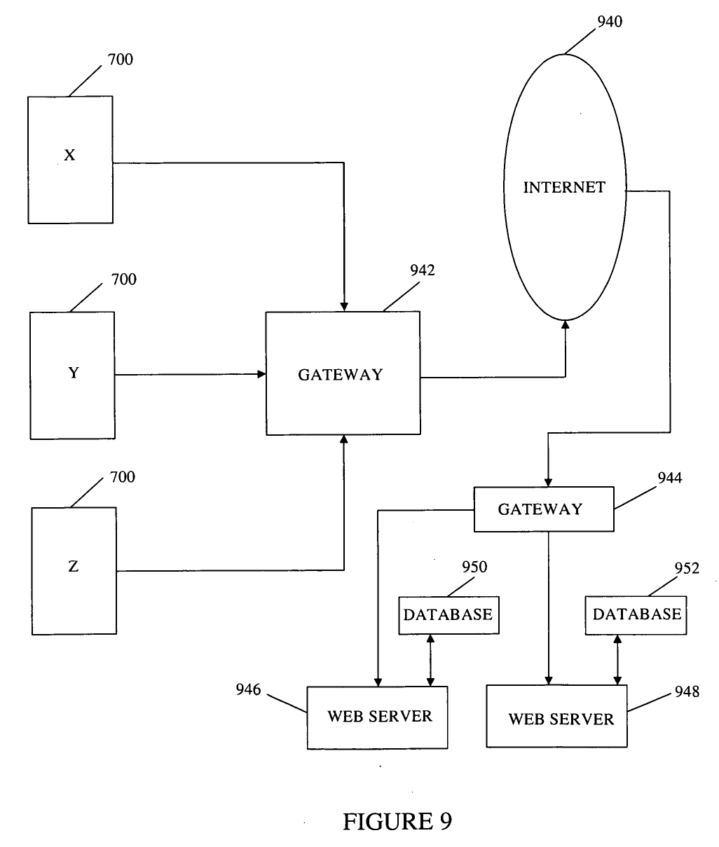

FIG. 9 shows a typical topology of a computer network with computers similar to computer 700, connected to the Internet. For illustration purposes, three computers X, Y, and Z are shown connected to the Internet 940 via the Web interface 818 (shown in FIG. 8) through a gateway 942, where the gateway 942 can interface N number of computers. The web interface 818 may be a modem, network interface card, or a unit for providing connectivity to other computer systems over a network using protocols such as X.25, Ethernet, or TCP/IP, or any device that allows, directly or indirectly, computer-to-computer communications.

A second gateway 944 may connect a network of web servers 946 and 948 to the Internet 942. The web servers 946 and 948 may be connected with each other over a computer network. The web servers 946 and 948 can provide content, including consumer information from a database 950 and/or 952. The web servers 946 and 948 can also host the behavior-based web page generation system, according to the disclosure.

The Internet 940 connects thousands of computers worldwide through well-known protocols, for example, Transmission Control Protocol (TCP)/Internet Protocol (IP), into a vast network. Information on the Internet is stored world wide as computer files, mostly written in the Hypertext Mark Up Language (“HTML”). Other mark up languages, e.g., Extensible Markup Language (“XML”) as published by W3C Consortium, Version 1, Second Edition, October 2000, ©W3C may also be used. The collection of all such publicly available computer files is known as the World Wide Web (“WWW”).

The WWW is a multimedia-enabled hypertext system used for navigating the Internet 940 and is made up of hundreds of thousands of web pages with images and text and video files, which can be displayed on a computer monitor. Each web page can have connections to other pages, which may be located on any computer connected to the Internet 940.

It is noteworthy that the disclosure is not limited to a particular number of computers. Any number of computers that can be connected to the Internet 940 or any other computer network may be used.

Moreover, a storage medium may represent one or more devices for storing data, including read-only memory (ROM), random access memory (RAM), magnetic disk storage mediums, optical storage mediums, flash memory devices and/or other machine readable mediums for storing information. The terms “machine readable medium” and “computer readable medium” include, but are not limited to portable or fixed storage devices, optical storage devices, and/or various other mediums capable of storing, containing or carrying instruction(s) and/or data.

Furthermore, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, circuit, and/or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

One or more of the components and functions illustrated in FIGS. 1, 2, 3, 4, 5, 6, 7, 8 and/or 9 may be rearranged and/or combined into a single component or embodied in several components without departing from the invention. Additional elements or components may also be added without departing from the invention. Additionally, the features described herein may be implemented in software, hardware, as a business method, and/or combination thereof.

While certain exemplary embodiments have been described and shown in the accompanying drawings, it is to be understood that such embodiments are merely illustrative of and not restrictive on the broad invention, and that this invention is not be limited to the specific constructions and arrangements shown and described, since various other modifications may occur to those ordinarily skilled in the art.

1. A method for assisting a sponsor with an online transaction, comprising:
securing funds for the online transaction;
obtaining an item selection from a third party voting group; and
authorizing access the funds to a merchant for purchasing the item for a recipient on behalf of the sponsor.

2. The method of claim 1, further comprising:
notifying one or more members of the voting group of the online transaction, the one or more members of the voting group selecting the item for the sponsor to provide to the recipient; and
notifying a transaction manager of the item selected by the one or more members of the voting group.

3. The method of claim 2, wherein the merchant and the transaction manager are the same entity.

4. The method of claim 2, further comprising:
collecting data from a plurality of online transactions and wherein the collected data is further analyzed to determine at least one of:
most selected items for a particular age group;
most selected items for a particular gender;
most selected items by price range;
most selected items by category;
most selected items by occasion; and
most selected items by geographical region.

5. The method of claim 4, further comprising:
distributing the collected data to merchants;
facilitating advertising of items by the merchants based on the collected data; and
displaying merchant advertising to the voter group to facilitate transactions.

6. The method of claim 1, further comprising:
depositing funds from the sponsor into an escrow account maintained by the transaction manager; and
transferring the funds to the merchant for purchasing the selected item.

7. The method of claim 1, wherein securing funds includes at least one of authorizing a merchant to charge a credit card of the sponsor or charging the sponsor directly for the selected item.

8. The method of claim 1, wherein the funds may be provided, in part or in full, by the sponsor, the merchant, a third party and/or the one or more members of the voting group.

9. The method of claim 1, wherein securing the funds initiates the online transaction.

10. The method of claim 1, wherein at least one of the sponsor, the transaction manager, the recipient and the voting group specify a deadline for the delivery of the item to the recipient.

11. The method of claim 1, wherein the sponsor and the recipient are the same person or entity.

12. The method of claim 1, wherein the item is a good and/or service.

13. The method of claim 1, wherein at least one of the transaction manager and the one or more members of the voting group request an increase in the funds.

14. The method of claim 1, wherein at least one of the transaction manager and the one or more members of the voting group select the item from a list of possible items or within parameters specified by the sponsor.

15. The method of claim 1, wherein the transaction manager makes the item selection based on the actions of the one or more members of the voting group.

16. The method of claim 1, wherein at least one of the sponsor and the recipient specifies, in part or in full, explicitly or implicitly, the one or more members in the voting group.

17. The method of claim 1, further comprising:
setting up lower and/or upper budget limits for the transaction.

18. A method operational by a transaction manager for assisting a sponsor with an online transaction, comprising:
receiving a gift request from the sponsor; and
notifying one or more members of a voting group of the online transaction, the one or more members of the voting group select an item to provide to a recipient; and
obtaining an item selected from the voting group.

19. A processing device adapted to implement assisting a sponsor with an online transaction, comprising:
means for securing funds for the online transaction;
means for obtaining an item selection from a third party voting group; and
means for authorizing access the funds to a merchant for purchasing the item for a recipient on behalf of the sponsor.

20. The processing device of claim 19, further comprising:
means for notifying one or more members of the voting group of the online transaction, the one or more members of the voting group select the item for the sponsor to provide to the recipient; and
means for notifying a transaction manager of the item selected by the one or more members of the voting group.
